(19) United States
(12) Patent Application Publication
(10) Pub. No.: US 2011/0055021 A1
(43) Pub. Date: Mar. 3, 2011

(54) Affiliate Network Hybrid Tracking System and Method

(75) Inventor: Matthew A. Haag, Moon Township, PA (US)

(73) Assignee: DIGITAL RIVER, INC., Eden Prairie, MN (US)

(21) Appl. No.: 12/872,832

(22) Filed: Aug. 31, 2010

Related U.S. Application Data
(60) Provisional application No. 61/238,503, filed on Aug. 31, 2009.

(51) Int. Cl. G06Q 30/00

(52) U.S. Cl. 705/14.69

(57) ABSTRACT

A system and method for determining a commission for an affiliate referral is described. Typically, affiliate tracking programs utilize a cookie deposited on an end user's computer to collect the data it needs to accurately associate a commission with an affiliate. If the cookie is lost for some reason (e.g. the user deletes cookies), that valuable information is missing, and the system must collect other information to determine the possible source of the referral. Two additional data collection and association pathways may be utilized to ensure that the commissions paid to affiliates are complete and accurate. These additional pathways include eTags and a caching system which enable cookieless tracking techniques. In addition a conversion breakdown report provides the data collection and user interface for an affiliate manager to determine in some circumstance to whom, among several possible affiliates, the commission should be given.

### RELATED APPLICATIONS

This application claims the benefit of U.S. Provisional Application No. 61/238,503 filed 31, August 2009, entitled “Conversion Breakdown System and Method,” which is incorporated herein by reference.

### FIELD OF THE INVENTION

The present invention relates to technology for tracking conversions in online affiliate marketing. In particular, it relates to accurately determining which affiliate should be credited with a commission for a sale or lead referral.

### BACKGROUND OF THE INVENTION

With the abundance of goods and services available to consumers through the online marketplace, a seller or merchant must efficiently connect an interested person with the appropriate information pertaining to the desired goods or services. A seller must advertise its universal resource locator (URL) in order to reach those users on the Internet that are interested in the goods or services offered. Online merchants often do this through the use of affiliate marketing networks. In an affiliate network, web sites and sellers create affiliate partnerships with others who have users (e.g. visitors or shoppers) with similar interests. Affiliates post marketing campaigns in the form of links, banner ads or the like. When the user clicks on the advertisement, an HTML link provides the user with a path or entry point to the seller's URL. Once at the seller's URL, the user may initiate a transaction. Completed transactions, such as a sale, or completion of a sales lead or interest form, are considered “conversions.” In other words, the internet user has converted from someone merely browsing to a customer or customer lead.

Affiliate marketers typically use pixel tracking and cookies to collect data regarding a consumer's actions or conversions on a web site. Consumers are redirected to a merchant's landing page through a tracking URL which writes a cookie containing the campaign, affiliate, date and miscellaneous information. The advertiser may place a pixel on a page that is displayed immediately after the action being tracked; when the consumer clicks on that page, the pixel fires and data is collected from the cookie.

From a high level perspective, pixel tracking works by placing a 1×1 image on a web page, campaign, banner advertisement, or other creative item. Unknown to the end user, the image directs the end user to a script that places a cookie on the user's computer, logs a click in the network database and then redirects the end user to the advertising merchant's web page. The cookie placed on the end user's computer contains text that allows the affiliate network system to associate an end user with the affiliate on whose creative item the user clicked. Whenever an end user performs a tracked action, the pixel “fires,” executing a script that reads the text of the cookie placed on the end user's computer.

Occasionally, a pixel fire may “fail.” If, for example, on completion of a conversion action, the pixel fires, sending its tracking script to the end user's browser but no cookie can be located. If it does not find the appropriate cookie on the browser, no action will be recorded. This could happen if a user deletes the cookies on his/her computer prior to a conversion. If the cookie is not available for any reason, the conversion can't be associated with the click and the affiliate cannot be compensated for driving the conversion.

Information read from the cookie is used to create a transaction in the tracking platform in order to provide the seller with sufficient information to make an accurate payout on the conversion. Conversions measure the success of an internet campaign, and are a key factor in determining commissions paid to affiliates in an affiliate network. The tracking pixel helps to identify visitors to a site and where they came from. Tracking also may be able to determine what search term was used to get the user to the conversion point.

Using cookies to track online user behavior is controversial. Many people do not understand how or why cookies are used. While many end users dislike cookies, others can appreciate the benefits of a merchant knowing the user's browsing history in order to determine what products or content most interests the user. In affiliate marketing, cookies have been a simple and accurate method for collecting data that allow accurate payouts. However, many users are deleting cookies, making it difficult to determine affiliate payouts. In addition, beginning in 2011, the European Union will require end users to accept cookies, which could severely limit the effectiveness of cookie-based tracking.

A need exists for extending the data collection process to include collecting the required user information when pixels fail to fire or cookies are unavailable, and translating the data into an appropriate commission payout. This disclosure describes a hybrid tracking system and method for getting to that complete and accurate commission and offers other advantages over the prior art.

### BRIEF SUMMARY OF THE INVENTION

A hybrid tracking system and method for tracking affiliate network conversions is disclosed. Such a system and method provide users with enhanced information and accuracy regarding their online marketing campaigns in order to properly credit an affiliate for the referral. A hybrid tracking system and method combines cookie tracking with cookieless tracking and a system and method of associating orphaned transactions (i.e. those transactions where no automatic association may be made) with an affiliate.

A preferred embodiment of the disclosed system and method uses eTags and a caching system to collect data on user online behavior when the user has rejected the setting of or deleted a cookie on his machine. The caching system sets the cookieless data on an eTag (which is used here synonymously with the term “cache pixel”) when a click script determines that a cookie will not be available on the user machine. It further determines if the cache pixel value gathered from the lead/sale tracking process can be matched to a click—a converted lead or sale.

If neither a cookie nor cache pixel allows for automatically associating the lead or sale to a click, the data for these orphaned transactions (also known as failed pixel fires) is collected and presented to the user in the form of a conversion breakdown report. Information and functionality is provided that allows administrative users to search for matching clicks based on the displayed information for a lead or sale. Displayed along with the unassociated lead or sale may be additional user machine-related information that can be used to potentially identify and associate the transaction to an affiliate click.

### BRIEF DESCRIPTION OF THE DRAWINGS

FIG. 1 is a context diagram depicting an environment in accordance with a preferred embodiment of a hybrid tracking system.

FIG. 2 illustrates the hardware associated with the environment of a preferred embodiment.

FIG. 3 is a flow diagram of the process used to set a cookie or eTag on a user's browser at the time the user accesses a click event.

FIG. 4 is a flow diagram of the process used to collect click data on a user who has completed a conversion event.

FIG. 5 shows the interaction between a web server(s) hosting affiliate web sites, an affiliate tracking database and one or more cache servers.

FIG. 6 is a graphic displaying possible search criteria for searching for matches in a conversion breakdown interface.

FIG. 7 is an example of a conversion breakdown “Failed Actions Report.”

FIG. 8 is an example of an expanded “Failed Actions Report” showing suggested affiliates and functionality to assign a conversion to an affiliate.

### DETAILED DESCRIPTION

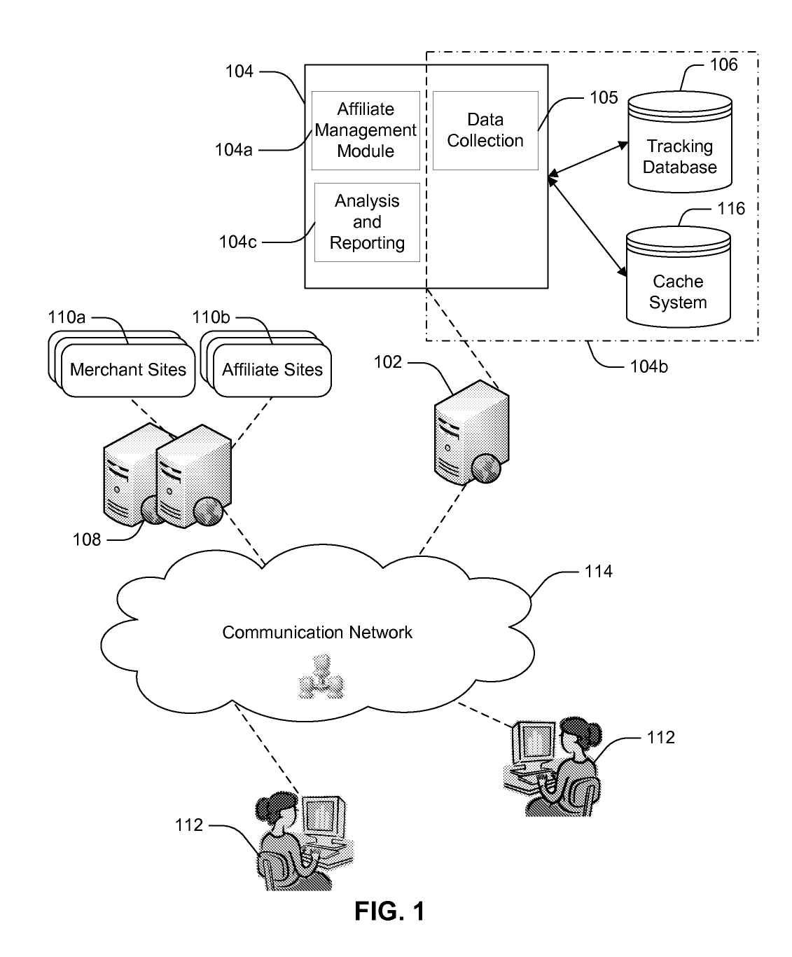

An exemplary affiliate marketing system is illustrated in context in FIG. 1. At a high level, an affiliate marketing system 104 is typically hosted on one or more web servers 102 and includes a number of software modules containing program code which when executed by a processor in the servers 102 facilitate the capture and storage 106 of data regarding an online merchant's 110a advertising campaigns and its partner (affiliate) web sites 110b. Collectively these elements form a hybrid affiliate tracking system as detailed below. The affiliate web sites 110b, also hosted on one or more servers 108, carry a merchant's marketing campaign ads for the purpose of driving the user to the merchant's site 110a to purchase an item or complete an event. Affiliates may become associated with the merchant in a number of ways. Typically, an affiliate network system provides an affiliate administrative management module 104a with a graphical user interface for site owners who wish to register an affiliate relationship and carry the merchant's advertising campaigns on their web sites 110b. Affiliates use the graphical user interface to register, configure accounting campaigns and provide and retrieve the appropriate tracking pixels to add to a web page. The system further has a data collection module 104b to gather and track data related to user online activity, in particular, clicks on campaign links or advertising and lead or sale activity. An exemplary data collection module 104b for a hybrid tracking system and method includes a data collection logic module 105, a tracking data base 106 for logging clicks, leads and sales or other transactions, and a cache system for cookieless tracking 116. An analysis and reporting module 104c provides a number of features, including calculating payouts to affiliates for conversions, and the conversion breakdown interface and report (described below) used to process unassociated conversions.

Affiliates receive a payout from a merchant when a shopper 112 accessing the site via a communication network such as the internet 114, is directed from the ad on the affiliate's site 110b to the merchant's site 110a and completes the designated event. Ideally, this shopper 112 navigation behavior is captured in a cookie placed on the shopper's computer, retrieved by a tracking pixel fire from the conversion event web page, and is stored in a universal tracking database 106. A merchant's web store may be hosted on site 110b, or by a third party ecommerce provider hosted on the same or another web server. With a hybrid tracking system and method, an affiliate marketing system also includes a caching system 116 designed to temporarily hold data regarding transactions with user computers that do not allow the use of cookies. The systems, modules and data structures that are used to gather and store data for and perform affiliate marketing communicate over the internet 114 using web services and technologies.

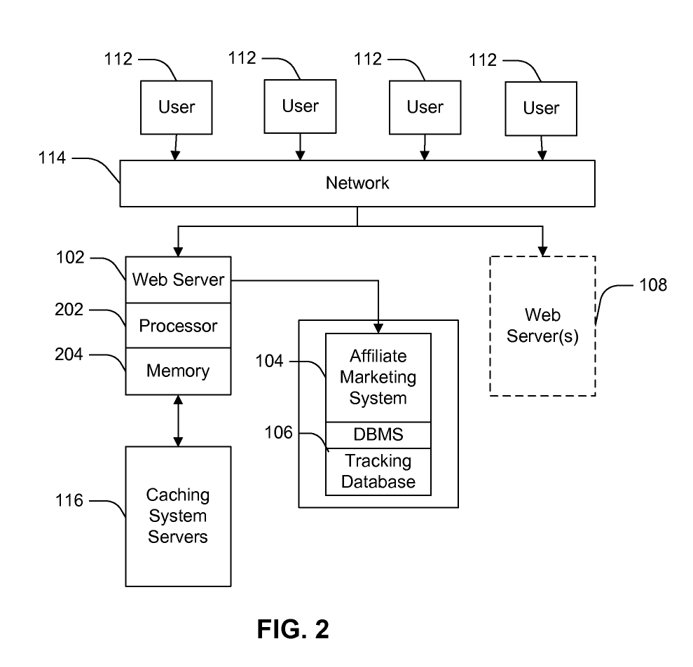

Referring to FIG. 2, the affiliate marketing hybrid tracking system includes one or more web servers or computing devices 102, each with at least one processor 202 and memory unit 204 storing instructions that when executed cause the processor 202 to execute the steps required to perform the method as described herein. The system operates within a distributed network that may include various configurations and computing devices, optimized to meet system requirements. A variety of servers, computers, computing devices or electronic devices may be part of the system, including, for example, end user machines 112, affiliate web site servers 108, an e-commerce system or platform, web services hosted on one or more computer servers (or other computing devices) 108, and one or more caching servers 116 (i.e., the caching system server). Each computer or computing device is connected to a network 114 such as the Internet or other type of data network. The number and configuration of web servers is offered by way of example and not limitation. One skilled in the art would recognize that there are many computing configurations available to carry out the system disclosed herein. Applications may be run locally or remotely with respect to the hybrid tracking system, as required.

Each computer, server, computing device or electronic device typically includes a memory 204, a secondary storage device, a processor (central processing unit, or CPU) 202, an input device, a display device, and an output device. The memory may include cache memory, random access memory (RAM) or other types of memory. Software applications (such as the affiliate marketing system 104 and the tracking database's 106 database management system (DBMS) stored in the memory or secondary storage for execution by a processor are operatively configured to perform the operations of the exemplary system. The software applications may correspond with a single module or any number of modules which are program code or instructions for controlling a computer processor to perform a particular method. The modules preferably implement the features or operations of the system. The modules may also be implemented using program products or a combination of software and specialized hardware components. In addition, the modules may be executed on multiple processors for processing a large number of transactions, if necessary or desired.

The secondary storage device may include a hard disk drive, floppy disk drive, CD-ROM drive, DVD-ROM drive, or other types of non-volatile data storage, and it may correspond with the various modules shown in the figures. The processor may execute the software applications or programs either stored in memory or secondary storage or received from the Internet or other network. The input device may include any device for entering information into computer, such as a keyboard, cursor-control device, or touch-screen. The display device may include any type of device for presenting visual information such as, for example, a computer monitor or flat-screen display. The output device may include any type of device for presenting a hard copy of information, such as a printer, and other types of output devices include speakers or any device for providing information in audio form.

Although the computer or computing device has been described with various components, one skilled in the art will appreciate that such a computer or computing device can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. One skilled in the art would recognize that computing devices may be client or server computers. Client computers and devices (e.g. 112) are those used by end users to access information from a server over a network, such as the Internet 114. Servers are understood to be those computing devices that provide services to other machines, and may be (but are not required to be) dedicated to hosting applications or content to be accessed remotely over a network by any number of client computers.

### Browser Tracking

Affiliate marketers typically use cookies and pixel tracking to collect information about transactions on web sites (i.e., user click and conversion behavior data). For example, an affiliate may place a tracking pixel on a merchant web page containing a conversion event, such as a form page or a shopping cart “Thank you” page. The affiliate may also create a script that executes upon a click on a banner ad or link, placing a cookie on the user's browser. When a user subsequently clicks on the link and is redirected to the web page where the tracking pixel has been installed and completes the event (e.g. filling out the form or making a purchase) the pixel fires, executing a data collection script. It will be appreciated by those skilled in the art that “clicking” as referred to herein means the interaction of a user with a user interface to select an object. One method of selecting an object involves a user moving a cursor over the object on a display device by moving a mouse, a trackball, touch stick, a finger tap on a touch pad, a finger tap on a touch screen, or the like.

If all goes well, the pixel script reads and returns the cookie information to the affiliate marketing system. The data is captured and stored in the database and an accurate association is made with the affiliate for payout of commissions.

However, if the pixel fire “fails,” for example, when the cookie has been deleted from the user's computer or is otherwise not found, the data used to make the association between a sale or lead and the driving affiliate could be lost. The pixel script still gathers various data elements from the transaction, such as the time stamp of the transaction, the IP address of the user's computer, the user agent or browser, the X-forwarded for (XFF) value, and any affiliate, campaign and banner identifiers. This data is collected and stored in the database. A conversion breakdown report, such as the one discussed below, allows a merchant to manually reconcile a conversion to the appropriate affiliate.

In a preferred embodiment, a hybrid tracking technique limits the number of pixel fire failures when cookies are not available by implementing cookieless tracking in addition to cookie tracking and manual association. While cookieless tracking may or may not be a substitute for cookie tracking, it can significantly enhance the accuracy of the affiliate-conversion associations.

In a preferred embodiment, cookieless tracking may be implemented with an HTTP e-Tag. eTags are primarily used for cache validation, but they may also be used to collect small amounts of information and cache it for later retrieval. An embodiment such as this preferred embodiment has the added benefit of alleviating problems resulting from excessively high database utilization. The use of eTags for this purpose requires that the user-agent does not disable caching on the computing device.

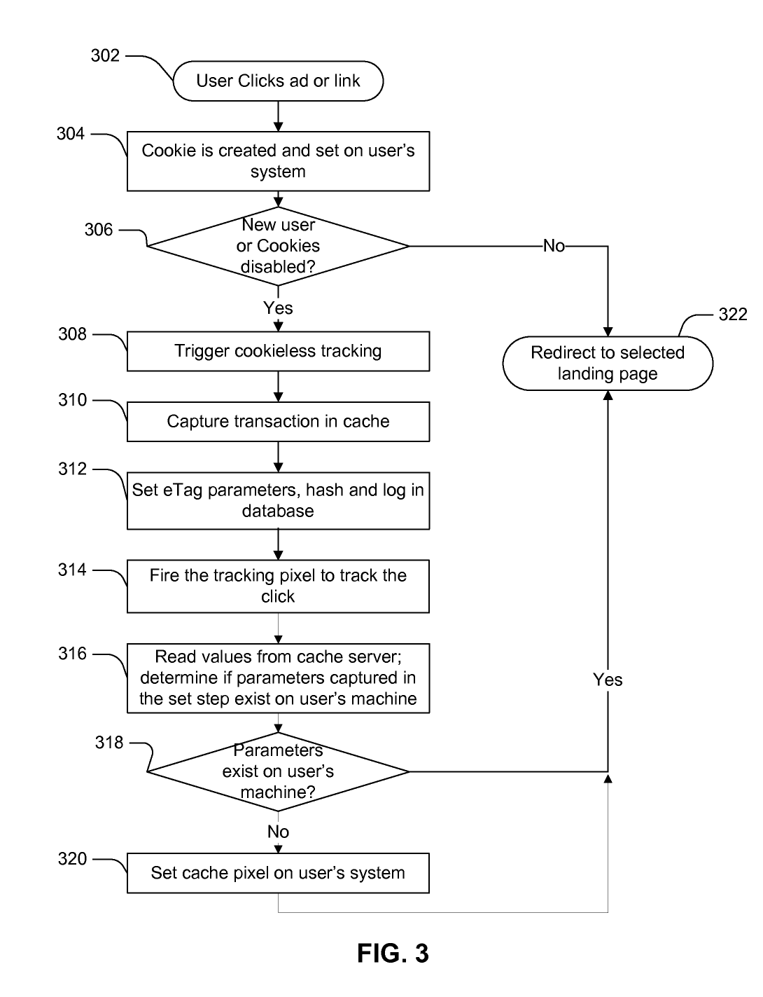

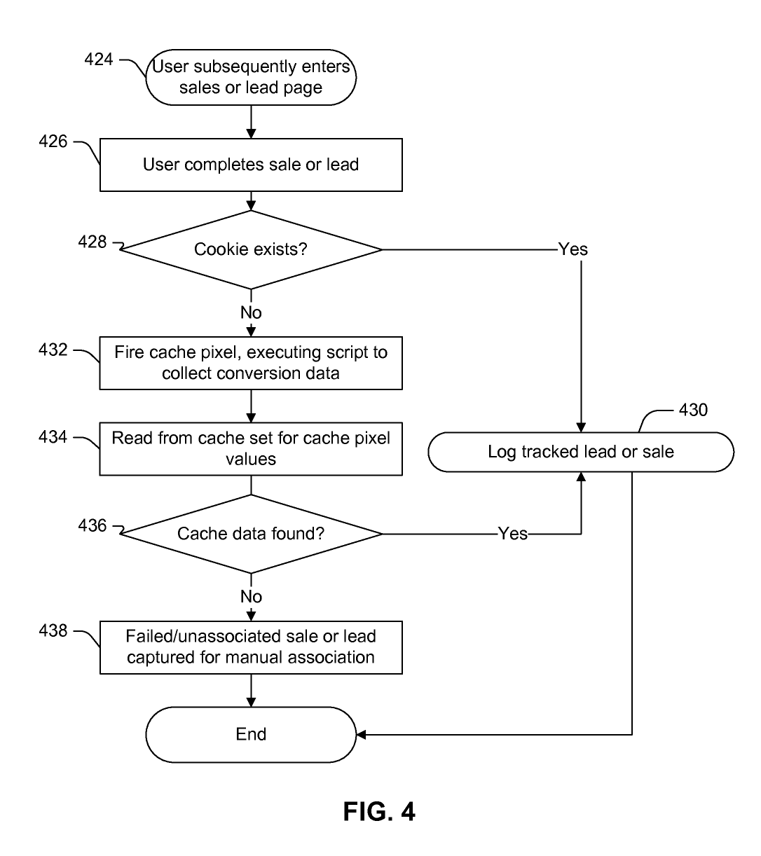

The eTag data collection process can utilize JavaScript or other similar technologies such as ActiveX to temporarily store tracking information in cache while switching between tracking scripts. The basic process flow is illustrated in FIGS. 3 and 4. In FIG. 3, a user browsing a web page clicks on a marketing campaign banner ad or link 302 and a tracking pixel is fired. A click script based on the tracking pixel creates a cookie 304 and sets it on the user's browser in the computing device 112. If the cookie is installed on the user's system 306, the user is immediately redirected to the selected destination landing page 322. If the user is new (i.e., not previously associated with the particular campaign) or has disabled cookies 306 on his browser, cookieless tracking is triggered 308. A record of the transaction is entered/stored in the caching server memory 310 (e.g., one of the servers 102 in the hybrid tracking system). A cache pixel, or eTag, is created with the information from that record 312 and associated with the URL for the tracking pixel. The eTag value is created or formed by hashing desired data collection variables, such as the program id, affiliate id, cookie id, date stamp, tracked value, tracked date, lead information and banner id. An example of a 32 character hash of this data may look something like this: 9a3f703b44eeefa40be0a216818a4 cc4. When created this eTag for the URL for the tracking pixel also is set on the user's computing device 112 as the cache pixel.

The tracking pixel is fired to collect the click behavior information 314 from the user's browser on the computer device 112. The caching server memory is read to determine if the parameters captured in step 312 also exist on the user's machine or computing device 316. If the parameters exist 318, then the cookieless tracking initial setup is complete and the user's browser on the computing device 112 is redirected to the selected destination landing page 322. If the parameters do not exist 318, then the cache pixel (or eTag) is set on the user's browser 320 on the computing device 112 and the user is redirected to the selected destination landing page 322.

Referring now to FIG. 4, the end user may subsequently complete a conversion event such as by navigating to a lead or sale page 424 (i.e., typically a conversion event occurs upon navigating through a transaction and landing on a thank you or confirmation page). If the user completes the lead or sale 426, then the tracking scripts that fire upon completiong first look for a cookie 428. If the tracking script finds a cookie data for the campaign, the conversion is logged 430 in the tracking database 106. If the tracking script is unable to find cookie data for the campaign or if cookieless tracking is used exclusively without first looking for cookie data, then a redirect to the URL for the tracking pixel for that campaign occurs 432 (i.e., the cache pixel is fired). The user's browser locates the eTag for the cache pixel on the computing device 112 and queries 434 the caching server 116 to determine whether the cache pixel (or eTag) value exists in the caching server 116 memory. When the eTag value exists or is found 436 in the caching server memory, the cache data (e.g., record of the transaction) associated with the eTag are matched to a click to track a conversion event and the conversion is logged 430 in the tracking database 106 (e.g., a converted lead or sale). If the cache data is not found 436 in the caching server memory, the transaction is captured as a failed or unassociated lead or sale 438.

The caching functionality of the preferred embodiment allows the system to temporarily store data when the system is shifting between tracking scripts. This functionality normally redirects to other scripts immediately, and is transparent to the client. In these scenarios, the cache pixel has to be the exact same address every time it's called in order to take advantage of caching (since browsers cache based on URL). To facilitate this, redirects such as the following must occur from tracking script to pixel:
/z/<banner>/<affiliate>/cache_pixel
/track_lead/<campaign>/cache_pixel
/track_sale/<campaign>/cache_pixel

When a browser passes information on the page that caused the redirect, it passes the original page that the client hit (for images it is the page that houses the image, and for clicks it is the page that first redirected to the page), but no indication of whether it was a lead, sale or click page. As such, a means to know what type of conversion (lead, sale or click) the cache pixel came from is required.

A solution to this problem is to use a caching system such as the open source distributed memory caching system such as Memcached. Memcached allows the system to pass data between scripts without affecting the URL, and does not require When used in this environment, Memcached is implemented on a set of web servers that cache the simple key-value pairs contained in the eTag. It is not a highly CPU intensive application, but there must be sufficient RAM to hold all cached items without excessive cache evictions due to memory limits. Table 1 lists an exemplary key-value specification for cached items in a cookieless tracking affiliate network.

TABLE 1
Key-Value Specification for Cached Items

| | | Value |
|---|---|---|
| Data type | Key Format | Format |
| Upgrade Name | Upgrades | Serialized |
| Mapping | | Array |
| Upgrades | {CLIENT_ID}_u | Delimited |
| | | Strings |
| Variable Name | Variables | Serialized |
| Mapping | | Array |
| Variables | {CLIENT_ID}_v{VARIABLE_ID} | String |
| Campaign List | {CLIENT_ID}_p_all | Serialized |
| (All) | | Array |
| Campaign List | {CLIENT_ID}_p_active | Serialized |
| (Active) | | Array |
| Campaign List | {CLIENT_ID}_p_inactive | Serialized |
| (Inactive) | | Array |
| Campaign List | {CLIENT_ID}_p_pending | Serialized |
| (Pending) | | Array |
| Campaign List | {CLIENT_ID}_p_deleted | Serialized |
| (Deleted) | | Array |
| Campaigns | {CLIENT_ID}_p{PROGRAM_ID}_{PROGRAM | Mixed |
| | COLUMN ID} | |
| Traffic Limits | {CLIENT_ID}_tl{PROGRAM ID}{i\|c\|l\|s}{d\|m\|t} | Integer |
| (Stats) | | |
| Affiliate List | {CLIENT_ID}_a_all | Serialized |
| | | Array |
| Affiliates | {CLIENT_ID}_a{AFFILIATE_ID}_{AFFILIATE_COLUMN | Mixed |
| | ID} | |
| Select Campaign | {CLIENT_ID}_cs{PROGRAM_ID}_{AFFILIATE_ID} | Integer |
| Access | | |
| Private Campaign | {CLIENT_ID}_cp{PROGRAM_ID}_{AFFILIATE_ID} | Integer |
| Access | | |
| Creatives (Text) | {CLIENT_ID}_b{BANNER_ID}_{BANNER COLUMN ID} | Mixed |
| Creatives (Image) | {CLIENT_ID}_b{BANNER_ID}_{BANNER COLUMN ID} | Mixed |
| Creatives (HTML) | {CLIENT_ID}_b{BANNER_ID}_{BANNER COLUMN ID} | Mixed |
| Creatives (Email) | {CLIENT_ID}_b{BANNER_ID}_{BANNER COLUMN ID} | Mixed |
| Creatives | {CLIENT_ID}_b{BANNER_ID}_{BANNER COLUMN ID} | Mixed |
| (Contextual) | | |
| Customer | {CLIENT_ID}_c | Serialized |
| Records | | Array |
| Intranet Users | {CLIENT_ID}_iu{INTRANET USER ID} | Serialized |
| | | Array |

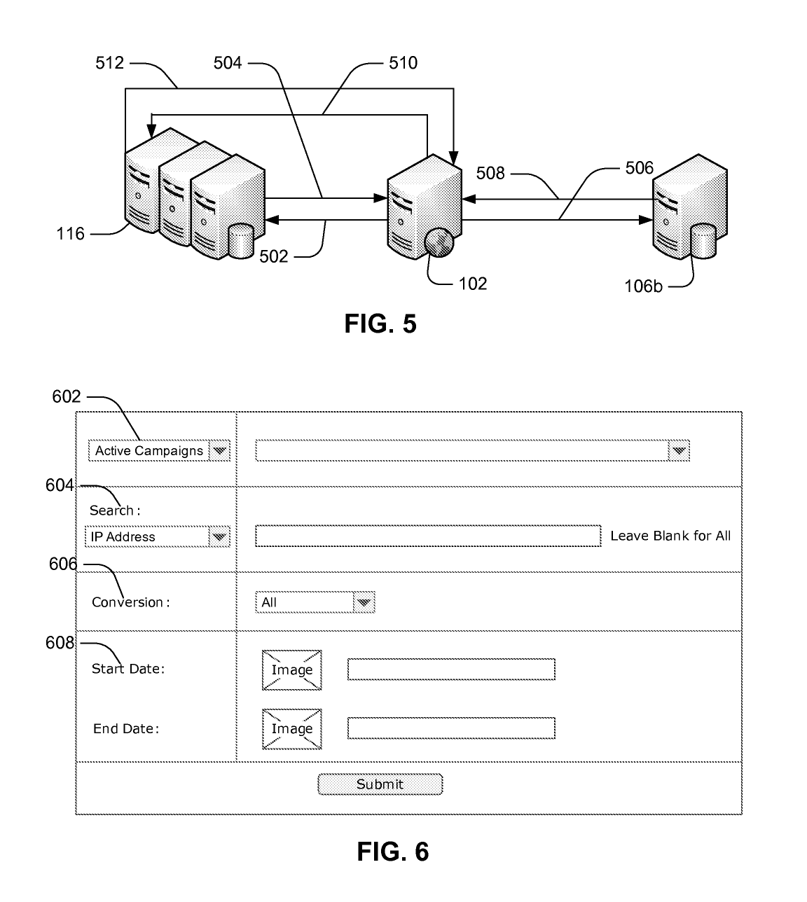

FIG. 5 illustrates the data flow between the web server and the cache and database servers. A pool of cache servers 116 may be implemented to ensure sufficient memory. A client library allows the web server 102 to access the data stored on the machines in the server pool 116. As used in this embodiment, a web server 102 requests 502 data from the cached server pool 116. The server pool returns 404 the data if it is available. If the data was not found in the server pool 504, or if it was expired, the web server 102 makes a request 506 to the database server 106b. The database server 106b returns the data 508. The web server 102 makes a request 510 to set the fresh data on the server pool 116, and the server pool returns 512 an indication of success or failure for the set operation.

The caching system is used for this purpose in the following way. The user navigates to the click URL. The system creates a hash of variations of HTTP header information (encoding, IP address, etc) and stores an array of the pertinent information required for a cache pixel. This data is written to the cache servers 116 using the hash as the key. When the cache pixel page is accessed, a call is made for a lookup in the cache server pool using the hash as the key. This works well because between near simultaneous requests the HTTP Header information will not change. Since the duration is so small clashes from clients form the same IP address is minimal. If, for any reason, the system is unable to capture the lead/sale/click via a cookie or cookieless tracking the converted transaction will continue to fall into a category of Failed Actions.

### Conversion Breakdown Reports and Interface

When cookie or cookieless transactions fail to collect affiliate association data, the conversions may be logged as pixel failures. An exemplary affiliate management system with hybrid tracking provides an analysis and reporting software module 104c. One of the functions of this module is to report data captured as a result of pixel failures. These data include leads and sales that cannot automatically be associated with a user click. The unassociated information is provided in the form of a reporting and assignment interface and application where administrative users can view the details of failed conversions and search for clicks that match certain criteria of failed pixel fire. The user is provided with the most likely affiliates for the data collected, and may assign the conversion to the one affiliate most likely to have driven the particular conversion.

In one embodiment of a universal tracking system, a conversion breakdown interface and report displays all conversions for an online marketing campaign. Users may search for unconverted clicks based on several criteria. An example of a search screen is shown in FIG. 6. Search criteria may include, campaigns by status (e.g. active, inactive, etc) campaigns 602, IP address 604, conversion action 606, and date range 608. If no matches are found, the report displays affiliates with clicks for the campaign before the given date.

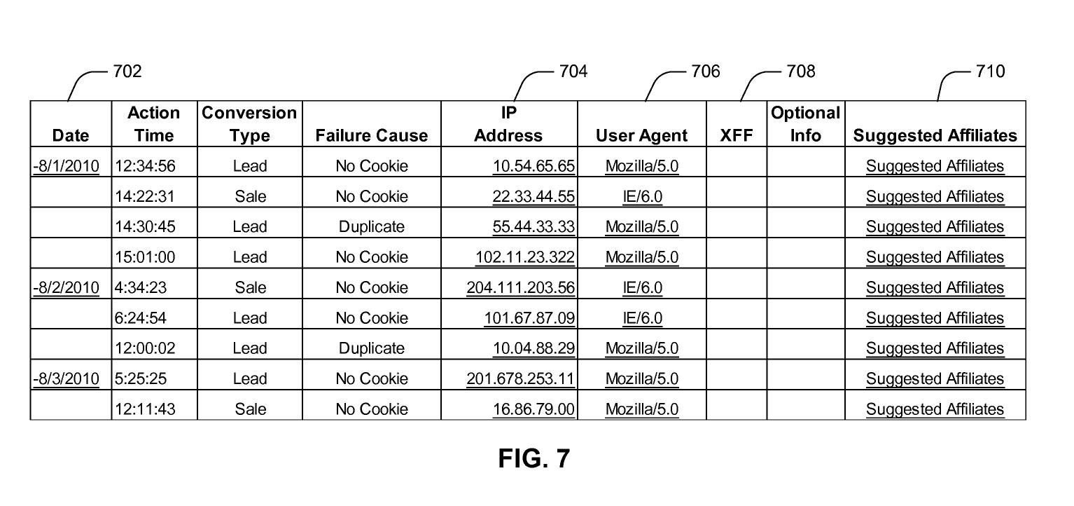

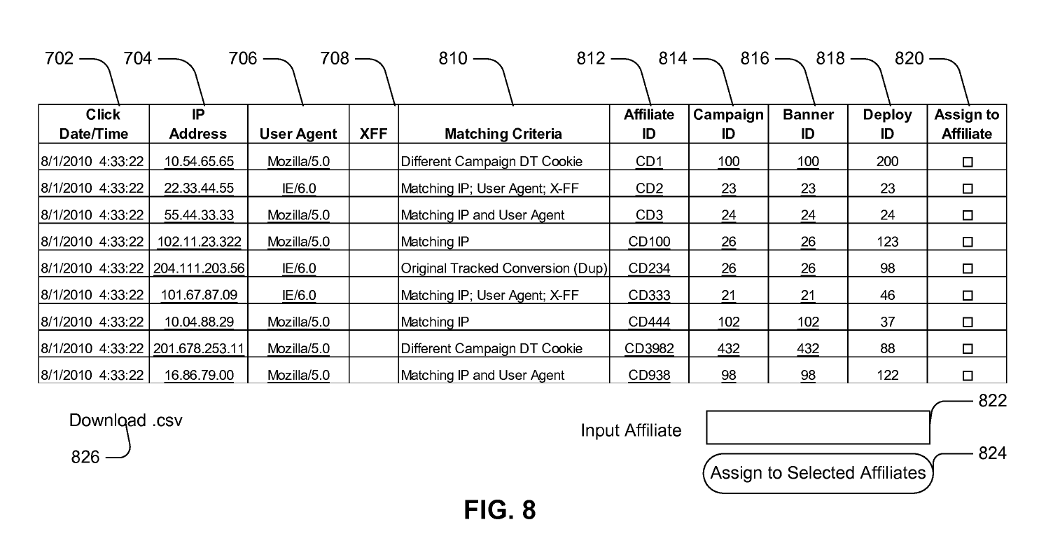

A Failed Actions report (FIG. 7) may list all conversions whether or not a complete data set has been captured. A hyperlink is added to a conversion breakdown report that directs the user to a list of all unconverted pixel fires. The list on the resulting page may be grouped by day 702 and may include a hyperlink for accessing all failed, or unconverted, conversions for the day. Displayed along with the failed conversion will be additional user machine related information 704, 706 and other information, such as the X-Forwarded For 708 value (an HTTP header that allows the user to determine the originating IP address) that can be used to potentially associate the failed conversion to an affiliate click. Suggested Affiliates 710 includes a link to an expanded report, illustrated in FIG. 8.

FIG. 8 shows the expanded Failed Action report view which is displayed when a user viewing a “Failed Actions Report” (FIG. 7) clicks on the expansion variable “Suggested Affiliates.” When a user clicks or otherwise selects on the display either an individual date 602 or an “expand all” option, rows are expanded that display all of the failed actions that occurred on the specified date. If the data is not accessible immediately, a data generating graphic displays. A click on the date 802 value collapses the row. The IP address 804 is a hyperlink to a Domain Tool site. Suggested affiliates 812, campaigns 814, banner ads 816 and deployment ids 818 are listed to aid in determining the appropriate affiliate to receive a commission.

The data in FIG. 8 as shown includes the clicks that matched the criteria selected in the “Expanded Failed Action” view. Matching criteria 810 are listed in Table 2, below.

TABLE 2
Matching Criteria

| Condition | Matching Criteria |
|---|---|
| Different Campaign | During pixel fire, if no cookie is stored for the given campaign then store |
| DT Cookie | any other non tracked cookies for the DT account for the failed details of |
| | that campaign |
| Original Tracked | During pixel fire if the cookie has already been tracked for campaign then |
| Conversion | store this information for failed details |
| (Duplicate) | |
| Matching IP, User | During pixel fire, store detailed information about the end user PC and |
| Agent, and/or X- | based on matching clicks for the same campaign before the given date of |
| Forward | the failed lead |
| No Cookie Failure | Different Campaign DT Cookie (for same account), IP/User Agent/X- |
| | Forward combo, IP and User Agent combo, Just matching IPs |
| Duplicate Failure | Originally Tracked Cookie, Different Campaign DT Cookie (for same |
| | account), IP/User Agent/X-Forward combo, IP and User Agent combo, |
| | Just matching IPs |
| Domain Auth Failure | Any non tracked DT cookies on machine (for same account), IP/User |
| | Agent/X-Forward combo, IP and User Agent combo, Just matching IPs |
| Inactive | Any non tracked DT cookies on machine (for same account), IP/User |
| | Agent/X-Forward combo, IP and User Agent combo, Just matching IPs |

The affiliate ID 812 is a hyperlink to the affiliate record. Hovering over the affiliate ID displays affiliate first name and last name and company. The banner ID 816 is a hyperlink that displays the ad similar to the functionality in the campaign itself. A checkbox 820 allows the user to assign the conversion to multiple affiliates. Affiliates are notified of the assignments. A display is offered to the user showing the number of actions that are assigned. User privileges need to be defined for assigning a failed action to an affiliate. If the user has access to the failed actions report then they have access to assign affiliates to failed leads.

Form functions may be provided on the bottom of the form. FIG. 8 illustrates a function allowing the user to assign affiliates by checking a check box 820 for the failed conversion, entering the affiliate name in a text box 822 and selecting the function button 824 “Assign to Selected Affiliates.” The user may also download 826 the data in a .csv file or other data file format compatible with the system.

The assignment of the failed action to an affiliate is then processed and stored in an audit report. Data collected includes the user, the time stamp, the campaign, the affiliate, and the number of actions assigned to that affiliate. Each affiliate submitted during the request will be treated as a separate record (e.g. user assigns 2 leads to CD4, and 3 leads to CD5, both the action for CD4 and CD5 will be a separate line item for the one given submit by the user). Once an affiliate(s) is assigned to a conversion then the failed conversion can be removed from the failed conversions report.

Other features of the administrative user interface include an average action conversion value and a display of a hyperlinked value of those campaigns converting less than x %, which may also be known as a conversion breakdown overview. The average action conversion value options include yesterday, a value that is hyperlinked directing the user to the conversion breakdown report listing all campaigns for the prior day; the last 30 days, which is recalculated during a process that runs each night to update affiliate assignments; the last 90 days, which is also recalculated during the overnight process. The value in this field is a hyperlink directing the user to a separate report listing all campaigns that fall within the selected criteria. Selection criteria requesting a display of a hyperlinked value of those campaigns converting less than x % allows the user to enter a percentage that will then add a hyperlink for creating a report that displays the data according to those parameters.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the hybrid tracking system such that different means of collecting cookieless data may be used to collect data when while maintaining substantially the same functionality without departing from the scope and spirit of the present invention.

What is claimed is:

1. A hybrid tracking system for collecting online user behavior and assigning an affiliate commission to an affiliate, the hybrid tracking system comprising a server with a processor, memory, input device, and further comprising:
an affiliate management module containing program code which when executed by the processor causes the server to perform operations of registering an affiliate, creating a marketing campaign, and storing a tracking pixel for download to affiliate web pages in response to user input entered through the input device;
a data collection module containing program code which when executed by the processor causes the server to perform operations of: (i) obtaining user click and conversion behavior data received by the server from an end user's computing device, and (ii) storing the received data in the memory; and
a reporting and analysis module containing program code which when executed by the processor causes the server to perform operations of (i) displaying conversion data unassociated with an affiliate in an assignment interface, and (ii) updating unassociated conversion data with manually assigned affiliates based on user input through the input device which indicates an affiliate to properly credit for the selected conversions.

2. The hybrid tracking system of claim 1 wherein the server memory comprises a tracking database and the data collection module program code which when executed by the processor causes the server to interacting with the tracking database.

3. The hybrid tracking system of claim 1 wherein the server memory comprises a cache memory and the data collection module program code which when executed by the processor causes the server to interacting with cache memory.

4. The hybrid tracking system of claim 1 wherein the reporting and analysis module comprises program code which when executed by the processor causes the server to determine commissions for affiliate conversions.

5. A method for assigning an affiliate commission to an affiliate in an affiliate tracking system having a server interacting through a network with a user's browser in a computing device, comprising steps of:
obtaining user click and conversion behavior data received by the server from an end user's computing device related to an affiliate marketing campaign;
displaying conversion data unassociated with an affiliate from the server in an assignment interface displaying unassigned conversions;
updating unassociated conversion data with manually assigned affiliates based on user input through an input device coupled to the server which indicates an affiliate to properly credit for the selected conversions; and
determining commissions for affiliate conversions based on the manually assigned affiliates.

6. A hybrid tracking system for collecting online user behavior and assigning an affiliate commission to an affiliate without using a cookie stored on a user's computing device, the hybrid tracking system comprising a server with a processor, memory, input device, and further comprising:
an affiliate management module containing program code which when executed by the processor causes the server to perform operations of registering an affiliate, creating a marketing campaign, and storing a tracking pixel for download to affiliate web pages in response to user input entered through the input device; and
a data collection module containing program code which when executed by the processor causes the server to perform operations of: (i) obtaining user click and conversion behavior data received by the server from an end user's computing device through the use of a script running on the end user's computing device, (ii) cookieless tracking is initiated by: storing a record in the hybrid tracking system server memory which comprises the obtained user click and conversion behavior data related to the universal resource locator (URL) for the tracking pixel, forming a cache pixel value associated with the record, and sending the cache pixel value to the user's computing device, (iii) cookieless tracking continues when a conversion event occurs by: redirecting a user's browser on the computing device to the URL for the tracking pixel, receiving a query from the computing device to determine whether a match to the cache pixel exists in the hybrid tracking system server memory, logging the conversion event as tracked when the match is determined.

7. The hybrid tracking system of claim 6 wherein the data collection module program code which when executed by the processor causes the server to form the cache pixel by hashing together some of the obtained user click and conversion behavior data to create an eTag value.

8. The hybrid tracking system of claim 6 wherein the cache pixel value is associated with the URL for the tracking pixel.

9. The hybrid tracking system of claim 6 wherein the obtained user click and conversion behavior data comprises campaign data selected from the group consisting of: program id, affiliate id, cookie id, date stamp, tracked value, tracked date, lead information and banner id.

10. The hybrid tracking system of claim 6 wherein the conversion event comprises a sale.

11. The hybrid tracking system of claim 6 wherein the conversion event comprises a lead.

12. The hybrid tracking system of claim 6 wherein the server memory comprises a tracking database and the data collection module program code which when executed by the processor causes the server to interact with the tracking database.

13. The hybrid tracking system of claim 6 wherein the server memory comprises a cache memory and the data collection module program code which when executed by the processor causes the server to interact with cache memory.

14. The hybrid tracking system of claim 6 further comprising a reporting and analysis module containing program code which when executed by the processor causes the server to determine a commission for an affiliate based on the logged conversion event.

15. A hybrid tracking method for collecting online user behavior and assigning an affiliate commission to an affiliate without using a cookie stored on a user's computing device, the hybrid tracking method network performed by a server having a processor and memory operating under the control of program code within a software module and comprising steps of:
registering an affiliate, creating a marketing campaign, and storing a tracking pixel for download to affiliate web pages in response to user input entered through the input device;
obtaining user click and conversion behavior data received by the server from an end user's computing device through the use of a script running on the end user's computing device,
initiating cookieless tracking by storing a record in the server memory, the record comprising the obtained user click and conversion behavior data related to the universal resource locator (URL) for the tracking pixel;
forming a cache pixel value associated with the record;
sending the cache pixel value to the user's computing device;
redirecting a user's browser on the computing device to the URL for the tracking pixel when a conversion event occurs;
receiving a query from the computing device to determine whether a match to the cache pixel exists in the server memory; and
logging the conversion event as tracked in the server memory when the match is determined.

16. The hybrid tracking method of claim 15 wherein the forming step comprises hashing together some of the obtained user click and conversion behavior data to create an eTag value as the cache pixel.

17. The hybrid tracking method of claim 15 wherein the cache pixel value is associated with the URL for the tracking pixel.

18. The hybrid tracking method of claim 15 wherein the obtained user click and conversion behavior data comprises campaign data selected from the group consisting of: program id, affiliate id, cookie id, date stamp, tracked value, tracked date, lead information and banner id.

19. The hybrid tracking method of claim 15 wherein the conversion event comprises a sale.

20. The hybrid tracking method of claim 15 wherein the conversion event comprises a lead.

21. The hybrid tracking method of claim 15 further comprising a step of determining a commission for an affiliate based on the logged conversion event in the server memory.
